(19) United States
(12) Patent Application Publication
(10) Pub. No.: US 2009/0273544 A1
(43) Pub. Date: Nov. 5, 2009

(54) Plasma display device and driving method thereof

(76) Inventor: Jin-Boo SON, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/453,091

(22) Filed: Apr. 29, 2009

(30) Foreign Application Priority Data
Apr. 30, 2008 (KR) 10-2008-0040203

(51) Int. Cl. G09G 3/28; G09G 5/00

(52) U.S. Cl. 345/60; 345/211

(57) ABSTRACT

A plasma display device includes an electrode performing a display operation, an inductor having a first end and a second end that is connected to a first power source supplying a first voltage, first and second switches connected in series between the first end of the inductor and the electrode, a third switch having a first end connected to a second power source that supplies a second voltage that is higher than the first voltage and a second end connected to the electrode, and a fourth switch connected between a node of the first and second switches and a third power source that supplies a third voltage that is lower than the first voltage.

### BACKGROUND OF THE INVENTION

1. Field of the Invention

Embodiments relate to a plasma display device and a driving method thereof.

2. Description of the Related Art

A plasma display device is a display device using a plasma display panel (PDP) that displays text or images using plasma generated by gas discharge. Such a PDP includes a plurality of discharge cells arranged in a matrix format.

In general, the plasma display device is driven by dividing a frame into a plurality of subfields each having a luminance weight value. In each subfield, discharge cells are reset through a reset discharge in a reset period, and light emitting cells and non-light emitting cells are selected by address discharge in an address period. In addition, sustain discharges are induced corresponding to the weight value of a corresponding subfield in a sustain period, thereby displaying images.

For this operation, a high-level voltage and a low-level voltage are alternately applied to electrodes where the sustain discharge is generated during the sustain period. In this instance, two electrodes where the sustain discharge is generated function as capacitive components, and therefore reactive power is required to apply the high-level voltage or the low-level voltage to the electrodes. Therefore, a sustain discharge circuit of the plasma display device includes an energy recovery circuit (ERC) for recovering and reusing reactive power.

The ERC has a complicated structure that includes an inductor connected to the electrode that performs the sustain discharge, a transistor that transmits the high-level voltage or the low-level voltage, a driving circuit for driving the transistor, a diode for preventing a reverse current, and a clamping diode connected to the inductor and preventing a voltage from exceeding an allowable voltage range.

With such a complicated structure, problems may occur in each constituent element of the ERC, e.g., a voltage drop of the transistor, a voltage drop of the diode, a leakage component of the inductor, a parasitic leakage resistance of the driving circuit, and so forth. Any one of these problems may result in an unstable sustain discharge.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display device and a driving method thereof, which overcome one or more of the disadvantages of the related art.

It is a feature of an embodiment to provide a plasma display device and a driving method thereof having a simplified energy recovery circuit.

It is another feature of an embodiment to provide a plasma display device and a driving method thereof having a reduced production cost.

It is another feature of an embodiment to provide a plasma display device and a driving method thereof having a more stably applied sustain pulse.

At least one of the above and other features and advantages may be realized by providing a plasma display device including an electrode that performs a display operation, an inductor having a first end and a second end, the second end being connected to a first power source that supplies a first voltage, first and second switches connected in series between the first end of the inductor and the electrode, a third switch having a first end connected to a second power source that supplies a second voltage that is higher than the first voltage, and a second end connected to the electrode, and a fourth switch connected between a node of the first and second switches and a third power source that supplies a third voltage that is lower than the first voltage.

At least one of the above and other features and advantages may be realized by providing a driving method for driving a plasma display device that includes an electrode that performs a display operation and first and second transistors connected in series to the electrode. The driving method may include increasing a voltage of the electrode through body diodes of the first and second transistors, applying a first voltage to the electrode, decreasing the voltage of the electrode through the body diodes of the second and first transistors, and applying a second voltage that is lower than the first voltage to the electrode through a node of the first and second transistors.

At least one of the above and other features and advantages may be realized by providing a plasma display device having a plasma display panel (PDP) including an electrode that performs a display operation and a driving circuit including first and second transistors connected in series to the electrode. The first transistor may include a first body diode, the second transistor may include a second body diode, and the driving circuit may apply a first voltage to the electrode after increasing a voltage of the electrode through the first transistor and the second body diode, may decrease the voltage of the electrode through the second transistor and the first body diode, and may apply a second voltage that is lower than the first voltage to the electrode through a node of the first and second transistors.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display device according to an exemplary embodiment of the present invention;

FIG. 2 illustrates driving waveforms of the plasma display device according to the exemplary embodiment of the present invention;

FIG. 3 schematically illustrates a sustain discharge circuit according to the exemplary embodiment of the present invention;

FIG. 4 illustrates signal timing of the sustain discharge circuit according to the exemplary embodiment of the present invention; and

FIG. 5A to FIG. 5D respectively illustrate current paths of the sustain discharge circuit according to the signal timing of FIG. 4.

### DETAILED DESCRIPTION OF THE INVENTION

Korean Patent Application No. 10-2008-0040203, filed on Apr. 30, 2008, in the Korean Intellectual Property Office, and entitled: “Plasma Display Device and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals indicate like elements throughout.

In addition, unless explicitly described to the contrary, the word “comprise” and variations such as “comprises” or “comprising” will be understood to imply the inclusion of stated elements but not the exclusion of any other elements.

In addition, wall charges mentioned in the following description mean charges formed and accumulated on a wall (e.g., a dielectric layer) close to an electrode of a discharge cell. Although the wall charges do not actually touch the electrodes, the wall charge will be described as being “formed” or “accumulated” on the electrode. A wall voltage is a potential difference formed on the wall of the discharge cell by the wall charges.

A plasma display device and a driving method thereof according to an exemplary embodiment of the present invention will now be described in further detail with reference to the drawings.

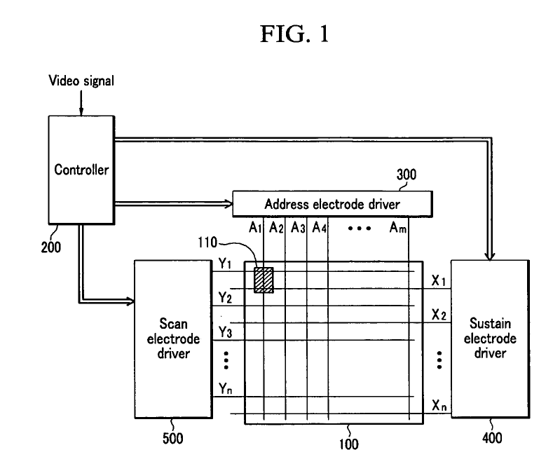

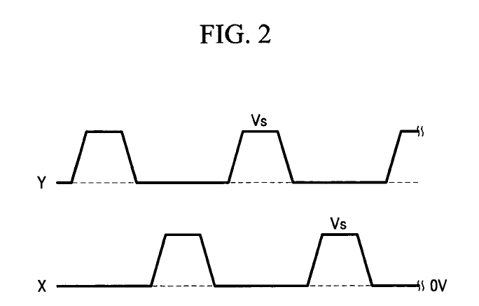

FIG. 1 illustrates a plasma display device according to an exemplary embodiment of the present invention. FIG. 2 illustrates driving waveforms of the plasma display device according to the exemplary embodiment of the present invention.

As shown in FIG. 1, the plasma display device may include a plasma display panel (PDP) 100, a controller 200, an address electrode driver 300, a sustain electrode driver 400, and a scan electrode driver 500.

The PDP 100 may include a plurality of address electrodes A1 to Am extending in a column direction, and a plurality of sustain and scan electrodes X₁ to Xₙ and Y₁ to Yₙ extending in a row direction by pairs. Hereinafter, an address electrode, a sustain electrode, and a scan electrode will be respectively referred to as an A electrode, an X electrode, and a Y electrode. Generally, the sustain electrodes X₁ to Xₙ are formed in correspondence to the respective scan electrodes Y₁ to Yₙ and the X electrodes X₁ to Xₙ and the Y electrodes Y₁ to Yₙ perform a display operation in the sustain period for displaying images. The Y electrodes Y₁ and Yₙ and the X electrodes X₁ to Xₙ perpendicularly cross the A electrodes A1 to Am. Herein, a discharge space formed at a crossing region of the A electrodes A1 to Am and the X and Y electrodes X₁ to Xₙ and Y₁ to Yₙ forms a discharge cell 110. This is an exemplary structure of the PDP 100, and embodiments may be used with PDPs of other structures.

The controller 200 may receive external video signals and output an A electrode driving control signal, an X electrode driving control signal, and a Y electrode driving control signal. In addition, the controller 200 may divide one frame into a plurality of subfields and may drive the subfields. Each subfield may include a reset period, an address period, and a sustain period with respect to time.

The reset period may reset a plurality of discharge cells 110. During the reset period, light emitting cells and non-light emitting cells may be selected. During the sustain period, sustain discharges may be generated a number of times corresponding to a weight value of a corresponding subfield in the light emitting cells. Herein, a grayscale of each cell is determined by a combination of weights of subfields. Some of the plurality of subfields may not include the reset period.

The controller 200 may change the video signal into subfield data that indicates the light emitting state in each subfield, and generate the A electrode driving control signal, the Y electrode driving control signal, and the X electrode driving control signal according to the subfield data and the number of sustain discharge generations in each subfield.

The address electrode driver 300 may receive the A electrode driving control signal from the controller 200 and apply a display data signal to each of the A electrodes A1 to Am for selecting light emitting cells and non-light emitting cells. The sustain electrode driver 400 may receive the X electrode driving control signal from the controller 200 and apply a driving voltage to an X electrode. The scan electrode driver 500 may receive the Y electrode driving control signal from the controller 200 and apply the driving voltage to a Y electrode.

In further detail, during an address period of each subfield, the address electrode driver 300, the sustain electrode driver 400, and the scan electrode driver 500 select light emitting cells and non-light emitting cells among the plurality of cells 110 in the corresponding subfield. During a sustain period of each subfield, as shown in FIG. 2, the scan electrode driver 500 applies a sustain discharge pulse that alternately has a high-level voltage Vs and a low-level voltage 0V to the Y electrodes Y₁ to Yₙ a number of times corresponding to a weight value of the corresponding subfield. The sustain electrode driver 400 applies a sustain pulse to the X electrodes X₁ to Xₙ with an opposite phase to that of the sustain pulse applied to the Y electrodes Y₁ to Yₙ. Thus, a voltage difference of each of the Y electrodes Y₁ to Yₙ and each of the X electrodes X₁ to Xₙ alternates between a voltage of Vs and a voltage of −Vs. Accordingly, a sustain discharge is repeatedly generated at the light emitting cell as many as the predetermined number of times.

The high-level voltage and the low-level voltage of the sustain pulse may be set to voltages other than the Vs voltage and 0V voltage described above. In this case, a voltage difference between a high-level voltage applied to one electrode (e.g., X electrode) and a low-level voltage applied to another electrode (e.g., Y electrode) should be a voltage (e.g., Vs voltage) that can generate a sustain discharge.

As a further alternative, a sustain pulse that alternately has a high-level voltage and a low-level voltage may be applied only to the Y electrodes, while the X electrodes X₁ to Xₙ are biased with a reference voltage (e.g. ground voltage). Herein, the high-level voltage is higher by the Vs voltage than the reference voltage, and the low-level voltage is lower by the Vs voltage than the reference voltage. As yet another alternative, the sustain pulse may be applied only to the X electrodes X₁ to Xₙ while the Y electrodes Y₁ to Yₙ are biased with the reference voltage.

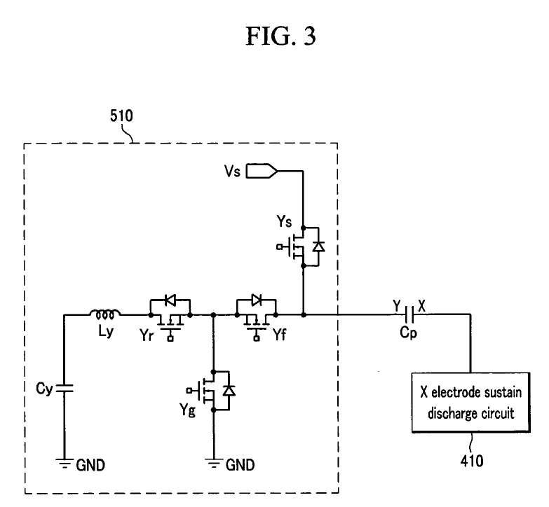

Hereinafter, a sustain discharge circuit that supplies the sustain pulse to the Y electrodes Y₁ to Yₙ will be described with reference to FIG. 3. FIG. 3 schematically illustrates the sustain discharge circuit according to the exemplary embodiment of the present invention.

In FIG. 3, one Y electrode Y and one X electrode X are illustrated for better understanding and ease of description, and a capacitive component formed by the Y electrode Y and the X electrode X is illustrated as a capacitor Cp. In addition, in FIG. 3, switches, e.g., transistors Ys, Yf, Yg, and Yr are respectively illustrated as n-channel field effect transistors, particularly as n-channel metal oxide semiconductor (NMOS) transistors. Each of the transistors Ys, Yf, Yg, and Yr may have a body diode formed in a source to drain direction thereof. In addition, other transistors having the same or a similar function may be used as the transistors Ys, Yf, Yg, and Yr instead of the NMOS transistor. Further, while the transistors Ys, Yf, Yg, and Yr are each illustrated as a single transistor in FIG. 3, they may be respectively formed by a plurality of transistors connected in parallel.

As shown in FIG. 3, the sustain discharge circuit of the plasma display device according to the exemplary embodiment of the present invention may include a Y electrode sustain discharge circuit 510 and an X electrode sustain discharge circuit 410. The sustain discharge circuits 510 and 410 may operate as an energy recovery circuit. The Y electrode sustain discharge circuit 510 may be connected to the Y electrodes Y₁ to Yₙ and may be formed in the scan electrode driver 500 of FIG. 1. The X electrode sustain discharge circuit 410 may be connected to the X electrodes X₁ to Xₙ and may be formed in the sustain electrode driver 400 of FIG. 1. In this particular example, the Y electrode sustain discharge circuit 510 and the X electrode sustain discharge circuit 410 may include the same constituent elements.

In the scan electrode driver 500, a predetermined element (e.g., a transistor) may be provided to apply waveforms to the Y electrode during the reset period and/or the address period. In this case, the Y electrode sustain discharge circuit 510 may be connected to the Y electrode Y via the predetermined element.

The Y electrode sustain discharge circuit 510 may include an inductor Ly, transistors Ys, Yf, Yg, and Yr, and a capacitor Cy. A drain of the transistor Ys may be connected to a power source Vs that supplies a high-level voltage Vs and a source of the transistor Ys may be connected to the Y electrode Y. A cathode of a body diode of the transistor Ys may be connected to the power source Vs. A drain of the transistor Yf may be connected to the Y electrode Y and a source of the transistor Yf may be connected to a source of the transistor Yr. In other words, the two transistors Yr and Yf may be connected in a back-to-back manner, and anodes of body diodes of the two transistors Yr and Yf may be connected to each other. A drain of the transistor Yg may be connected to a node of the transistors Yr and Yf, i.e., the drain of the transistor Yg may be connected to sources of the transistor Yr and Yf, and a source of the transistor Yg may be connected to a power source (e.g., ground) that supplies a low-level voltage (0V). A cathode of a body diode of the transistor Yg may be connected to the node of the two transistors Yr and Yf.

A first end of the inductor Ly may be connected to the drain of the transistor Yr and a second end of the inductor Ly may be connected to the capacitor Cy. The capacitor Cy may supply a voltage between the high-level voltage Vs and the low-level voltage 0V, e.g., an intermediate voltage Vs/2 between the two voltages Vs and 0V.

The Y electrode sustain discharge circuit 510 may increase or decrease a voltage of a Y electrode of a panel capacitor Cp by using a resonance of the inductor Ly and the panel capacitor Cp. In addition, the Y electrode sustain discharge circuit 510 may apply the Vs voltage or the 0V voltage to the Y electrode Y according to switching operation of the transistors Ys and Yg.

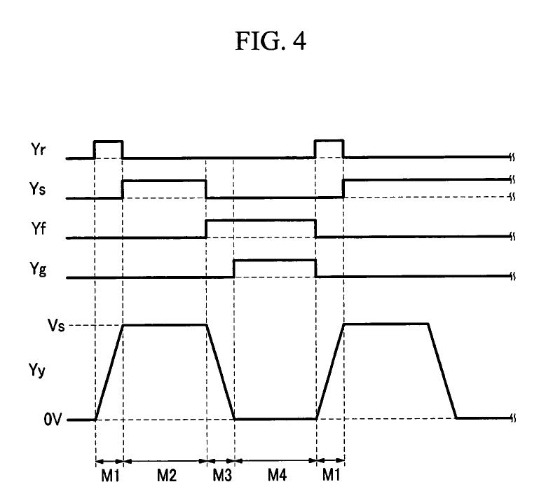

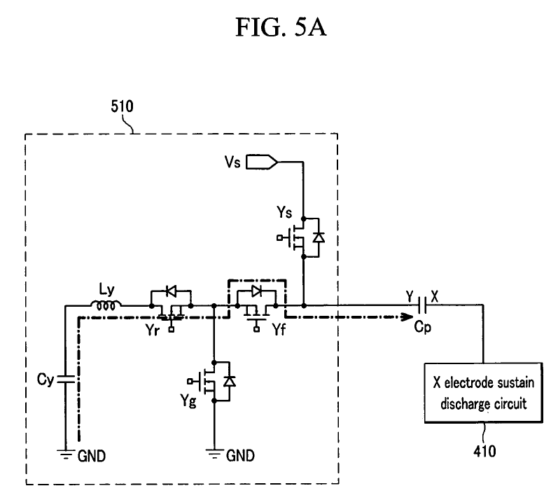

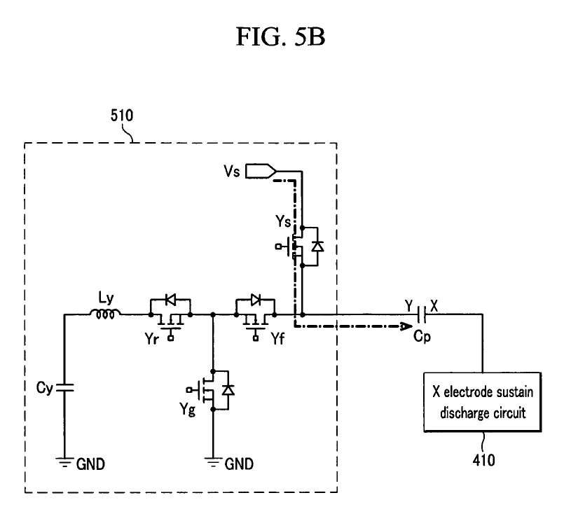

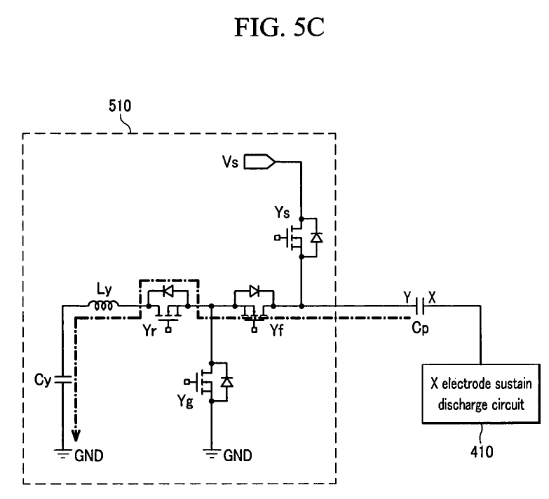

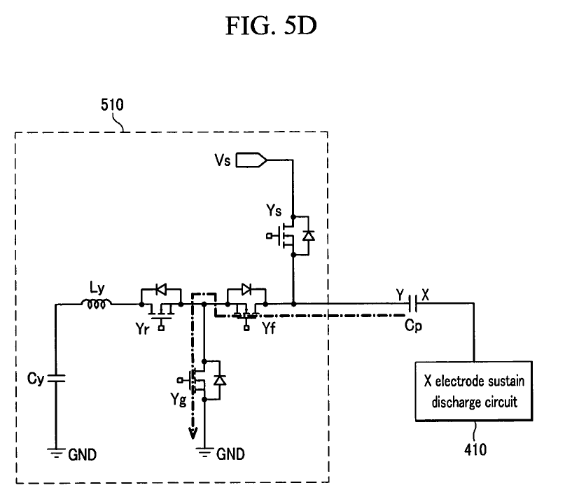

Operation of the sustain discharge circuit of FIG. 3 will be described in further detail with reference to FIG. 4 and FIG. 5A to FIG. 5D. FIG. 4 illustrates a signal timing of the sustain discharge circuit according to the exemplary embodiment of the present invention. FIG. 5A to FIG. 5D respectively illustrate current paths of the sustain discharge circuit according to the signal timing of FIG. 4.

First, it is assumed that the 0V voltage is applied to the Y electrode Y before a mode 1 M1 begins. Referring to FIG. 4 and FIG. 5A, in the mode 1 M1, the transistor Yr is turned on and a current path of the capacitor Cy, the inductor Ly, the transistor Yr, the body diode of the transistor Yf, and the panel capacitor Cp is formed. At this time, a resonance is generated between the inductor Ly and the panel capacitor Cp. Then, a voltage Vy of the Y electrode Y increases by the resonance of the inductor Ly and the panel capacitor Cp. In this instance, if the capacitor Cy is charged with the Vs/2 voltage and no parasitic component exists in a rising path of the voltage Vy of the Y electrode Y, the voltage Vy of the Y electrode Y may increase to the Vs voltage. However, if the parasitic component exists or the voltage of the capacitor Cy differs from the Vs/2 voltage, the voltage Vy of the Y electrode Y may only increase to be close to the Vs voltage.

As shown in FIG. 4, in a mode 2 M2, the transistor Yr is turned off and the transistor Ys is turned on so that a current path of the power source Vs, the transistor Ys, and the panel capacitor Cp is formed, as shown in FIG. 5B. Then, the Vs voltage is applied to the Y electrode Y and the voltage Vy of the Y electrode Y is maintained at the Vs voltage.

Referring to FIG. 4 and FIG. 5C, in a mode 3 M3, the transistor Ys is turned off and the transistor Yf is turned on so that a current path of the panel capacitor Cp, the transistor Yf, the body diode of the transistor Yr, the inductor Ly, and the capacitor Cy is formed. In this instance, a resonance is generated between the inductor Ly and the panel capacitor Cp. Then, the voltage Vy of the Y electrode Y decreases from the Vs voltage due to the resonance of the inductor Ly and the panel capacitor Cp. At this time, as previously described, the voltage Vy of the Y electrode Y may decrease to the 0V if the capacitor Cy is charged with the Vs/2 voltage and no parasitic component exists in a falling path of the voltage Vy of the Y electrode Y. However, if the parasitic component exists or the voltage of the capacitor Cy differs from the Vs/2 voltage, the voltage Vy of the Y electrode Y may only decrease to be close to the 0V voltage.

As shown in FIG. 4, in a mode 4 M4, the transistor Yf is maintained in the turn-on state and the transistor Yg is turned on so that a current path of the panel capacitor Cp, the transistor Yf, and the transistor Yg is formed, as shown in FIG. 5D. Then, the 0V voltage is applied to the Y electrode Y so that the voltage Vy of the Y electrode Y is maintained at the 0V voltage.

The Y electrode sustain discharge circuit 510 may apply a sustain pulse alternately having the low voltage 0V and the high voltage Vs to the Y electrode Y by repeating operations of the mode 1 to mode 4 M1 to M4 by a number of times corresponding to a weight value of the corresponding subfield during the sustain period. Further, the X electrode sustain discharge circuit 410 may apply a sustain pulse alternately having the low voltage 0V and the high voltage Vs to the X electrode X with an opposite phase to that of the sustain pulse applied to the Y electrode Y.

In the Y electrode sustain discharge circuit 510, a reverse current that may be formed by the body diode of the transistor Yr may be blocked by the turned-off transistor Yf and a reverse current that may be formed by the body diode of the transistor Yf is blocked by the turned-off transistor Yr. Thus, as compared with conventional circuits, a diode for blocking the reverse currents formed by the body diodes of the transistor Yr and Yf may be eliminated.

In addition, when a voltage at the first end of the inductor Ly is higher than the high voltage Vs while the voltage Vy of the Y electrode Y is increasing, the voltage Vy of the Y electrode Y may be prevented from being higher than an allowable voltage range, i.e., the high voltage Vs, through the current path of the inductor Ly, the transistor Yr, the body diode of the transistor Yf, and the body diode of the transistor Ys. In addition, when the voltage at the first end of the inductor Ly is lower than the 0V voltage while the voltage Vy of the Y electrode is decreasing, the voltage Vy of the Y electrode Y may be prevented from being lower than an allowable voltage range, i.e., the low voltage 0V, through the current path of the body diode of the transistor Yg and the body diode of the transistor Yr. In other words, since the transistors Yr, Yf, Ys, and Yg may perform a clamping function using their body diodes, a clamping diode needed in the conventional circuit may be eliminated.

As described above, an ERC according to embodiments may be simpler, reducing production costs. Further, occurrence of problems caused by a complicated configuration may be prevented.

In addition, as previously described, when the sustain pulse has a high-level voltage and/or a low-level voltage other than the Vs voltage and/or the 0V voltage, the corresponding high-level and low-level voltages can be used instead of the Vs voltage and the 0V voltage in FIG. 3.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
an electrode that performs a display operation;
an inductor having a first end and a second end, the second end being connected to a first power source that supplies a first voltage;
first and second switches connected in series between the first end of the inductor and the electrode;
a third switch having a first end connected to a second power source that supplies a second voltage that is higher than the first voltage and a second end connected to the electrode; and
a fourth switch connected between a node of the first and second switches and a third power source that supplies a third voltage that is lower than the first voltage.

2. The plasma display device as claimed in claim 1, wherein:
the first switch includes a first transistor and a first body diode;
the second switch includes a second transistor and a second body diode; and
an anode of the first body diode and an anode of the second body diode are connected to the node of the first and second switches.

3. The plasma display device as claimed in claim 2, wherein:
when the first transistor is turned on, a path for increasing a voltage of the electrode is formed through the inductor, the first transistor, and the second body diode; and
when the second transistor is turned on, a path for decreasing the voltage of the electrode is formed through the second transistor, the first body diode, and the inductor.

4. The plasma display device as claimed in claim 1, wherein:
the third switch includes a third transistor and a third body diode;
the fourth switch includes a fourth transistor and a fourth body diode;
a cathode of the third body diode is connected to the second power source; and
a cathode of the fourth body diode is connected to the node of the first and second switches.

5. The plasma display device as claimed in claim 4, wherein:
when the third switch is turned on, the second voltage is applied to the electrode, and
when the second and fourth switches are turned on, the third voltage is applied to the electrode.

6. The plasma display device as claimed in claim 1, wherein the first power source includes a capacitor.

7. The plasma display device as claimed in claim 1, wherein the first voltage is an average of the second and third voltages.

8. A driving method of a plasma display device that includes an electrode that performs a display operation and first and second transistors connected in series to the electrode, the driving method comprising:
increasing a voltage of the electrode through body diodes of the first and second transistors;
applying a first voltage to the electrode;
decreasing the voltage of the electrode through the body diodes of the second and first transistors; and
applying a second voltage that is lower than the first voltage to the electrode through a node of the first and second transistors.

9. The driving method as claimed in claim 8, wherein applying the first voltage comprises turning on a third transistor connected between a power source that supplies the first voltage and the electrode.

10. The driving method as claimed in claim 8, wherein applying the second voltage comprises turning on a fourth transistor and the second transistor, the fourth transistor being connected between the node of the first and second transistors and a power source that supplies the second voltage.

11. The driving method as claimed in claim 8, wherein:
increasing the voltage of the electrode includes forming a resonance between an inductor and the electrode through the first transistor and the body diode of the second transistor, the inductor being connected between a power source that supplies a third voltage that is between the first and second voltages and the first transistor; and
decreasing the voltage of the electrode includes forming a resonance between the inductor and the electrode through the second transistor and the body diode of the first transistor.

12. The driving method as claimed in claim 11, wherein the third voltage is supplied from a capacitor.

13. The driving method as claimed in claim 11, wherein the third voltage is an average of the first and second voltages.

14. A plasma display device, comprising:
a plasma display panel (PDP) including an electrode that performs a display operation; and
a driving circuit including first and second transistors connected in series to the electrode, wherein
the first transistor includes a first body diode and the second transistor includes a second body diode, and
the driving circuit applies a first voltage to the electrode after increasing a voltage of the electrode through the first transistor and the second body diode, decreases the voltage of the electrode through the second transistor and the first body diode, and applies a second voltage that is lower than the first voltage to the electrode through a node of the first and second transistors.

15. The plasma display device as claimed in claim 14, wherein the driving circuit further comprises an inductor connected between the first transistor and a third power source that supplies a third voltage that is lower than the first voltage and higher than the second voltage, and the driving circuit increases or decreases the voltage of the electrode through a resonance between the inductor and the electrode.

16. The plasma display device as claimed in claim 15, wherein the third power source includes a capacitor.

17. The plasma display device as claimed in claim 15, wherein the third voltage is an average of the first and second voltages.

18. The plasma display device as claimed in claim 14, wherein the driving circuit further comprises a third transistor connected between the node of the first and second transistors and a power source that supplies the second voltage, wherein the plasma display device turns on the second and third transistors to apply the second voltage to the electrode.

19. The plasma display device as claimed in claim 14, wherein an anode of the first body diode and an anode of the second body diode are connected to the node of the first and second transistors.
